(19) United States
(12) Patent Application Publication
(10) Pub. No.: US 2025/0274060 A1
(43) Pub. Date: Aug. 28, 2025

(54) Self-Charging Tool Device

(71) Applicants: Bruce Baum, Santa Fe Springs, CA (US); Phillip Baum, Santa Fe Springs, CA (US)

(72) Inventors: Bruce Baum, Santa Fe Springs, CA (US); Phillip Baum, Santa Fe Springs, CA (US)

(21) Appl. No.: 18/808,255

(22) Filed: Aug. 19, 2024

Related U.S. Application Data
(60) Provisional application No. 63/558,295, filed on Feb. 27, 2024.

(51) Int. Cl. H02N 11/00; H02J 7/00

(52) U.S. Cl. CPC H02N 11/008; H02J 7/0014; H02J 7/0063; H02J 7/0068

(57) ABSTRACT

A self-charging tool device is disclosed that eliminates the need for tool chargers. The self-charging tool device comprises a rotary engine that is attached to a power generator. As the rotary engine powers the tool, the generator collects the mechanical energy created by the engine and converts it to electrical energy that will be stored in an internal battery. Further, the device consists of an internal motor and micro generator system connected to one another. A double battery and cell system would then alternate power at a specific point of charge to optimize drill performance and maintain a balance of readily available power. This will keep the tool permanently charged and eliminate the need for a tool charger. Further, the outer shell would be comprised of a hard plastic to maximize durability of the device.

### CROSS-REFERENCE TO RELATED APPLICATION

The present application claims priority to, and the benefit of, U.S. Provisional Application No. 63/558,295, which was filed on Feb. 27, 2024, and is incorporated herein by reference in its entirety.

### FIELD OF THE INVENTION

The present invention relates generally to the field of self-charging tool devices. More specifically, the present invention relates to a self-charging power tool capable of generating enough power to maintain activation of the tool without charging batteries or a power outlet. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in self-charging tool devices. Generally, when being used, power tools consume batteries or require an electrical connection to maintain power. Thus, people must spend time charging the batteries which can take away workplace efficiency. Further, significant money is wasted using electricity to charge power tools or purchasing new batteries. Additionally, people may be forced to find storage and transportation for several batteries while working.

Furthermore, power tools which require an electrical connection or batteries to maintain power are not reliable in operation, as they are dependent on a fully charged battery. Operating at low battery levels can be unsafe and damage the power tool. Additionally, if the power tool uses hydraulic pressure, wind-force or an electric power source, it can produce unpleasant gas, vibration and noise, etc.

Accordingly, there is a demand for an improved self-charging tool device that provides a tool that is capable of generating enough power to maintain activation of the tool without charging batteries. More particularly, there is a demand for a self-charging tool device that features an internal generator that sends power to a battery as the tool is active.

Therefore, there exists a long felt need in the art for a self-charging tool device that provides users with a power tool capable of generating enough power to maintain activation of the tool without charging batteries or a power outlet. There is also a long felt need in the art for a self-charging tool device that features an internal generator that sends power to a battery as the tool is active. Further, there is a long felt need in the art for a self-charging tool device that spins the generator as the tool is being used to generate power and store power within an internal battery. Moreover, there is a long felt need in the art for a device that maintains endless and continuous operation of the tool without the need for a battery charger. Further, there is a long felt need in the art for a self-charging tool device that utilizes a rotary engine attached to the power generator. Finally, there is a long felt need in the art for a self-charging tool device that has a hard plastic shell to maximize durability.

The subject matter disclosed and claimed herein, in one embodiment thereof, comprises a self-charging tool device. The device is a set of self-charging power tools that are designed to eliminate the need for tool chargers. The self-charging tool device comprises a rotary engine that is attached to a power generator. As the rotary engine powers the tool, the generator collects the mechanical energy created by the engine and converts it to electrical energy that will be stored in an internal battery. Further, the device consists of an internal motor and micro generator system connected to one another. A double battery and cell system would then alternate power at a specific point of charge to optimize drill performance and maintain a balance of readily available power. This will keep the tool permanently charged and eliminate the need for a tool charger. Further, the outer shell would be comprised of a hard plastic to maximize durability of the device.

In this manner, the self-charging tool device of the present invention accomplishes all of the forgoing objectives and provides users with a device that generates and stores power. The device is a power tool that doesn't need charging via batteries or a power outlet. The device can comprise a hard plastic outer shell.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a self-charging tool device. The self-charging tool device comprises a rotary engine that is attached to a power generator. As the rotary engine powers the tool, the generator collects the mechanical energy created by the engine and converts it to electrical energy that will be stored in an internal battery. This will keep the tool permanently charged and eliminate the need for a tool charger.

In one embodiment, the self-charging tool device provides a set of self-charging power tools that are designed to eliminate the need for tool chargers. Typically, hand-held power tools are adapted with the device, but other suitable power tools can be utilized as well. For example, suitable power tools can include, but are not limited to, a drill, a sander, a grinder, a circular saw, etc., or any other suitable hand-held power tool as is known in the art, depending on the needs and/or wants of a user.

In one embodiment, the self-charging tool device comprises a rotary engine that is attached to a power generator. The rotary engine is a conventional rotary engine that uses electrical energy to spin rotors to power the tool. The rotary engine powers the hand-held power tool, and the power generator collects the mechanical energy created by the rotary engine and converts it to electrical energy that will be stored in an internal battery system. Specifically, as the rotors of the rotary engine spin, they act to spin the generator shaft which creates electrical energy for powering the device. The power generator is a gear driven micro generator connected with smaller gears to the shaft of the drill. As the drill spins it will also spin the micro generator, powering the stored batteries. When one battery reaches low power, the drill automatically alternates to the secondary battery allowing for the first one to charge.

In one embodiment, the rotary engine and the power generator connect to one another and to an internal double battery system (i.e., a first and second internal battery) to power the device. Thus, once the power generator produces a predetermined amount of electrical energy, it is then stored in a first internal battery. While this is occurring, the second internal battery is powering the rotary engine to spin or rotate. Then, whenever the first internal battery is fully charged and/or the second internal battery is empty, an electric switch is provided which allows the power generator to then charge the second internal battery while the first internal battery is then used to power the rotary engine. Accordingly, the electric switch is provided to be able to switch between the first and second internal batteries, as necessary. Thus, the first and the second internal batteries are charged to a predetermined level and/or depleted to a certain level when the electric switch is activated to transfer power supplies between the internal batteries. Accordingly, the double internal battery system would then alternate power at a specific point of charge to optimize drill (i.e., tool) performance and maintain a balance of readily available power. This will keep the device permanently charged and eliminate the need for a tool charger.

In one embodiment, the self-charging tool device comprises a controller in communication with the electric switch and the internal batteries. In use, the controller detects the internal battery supplies, and triggers the electric switch, which allows recharging automatically of the internal batteries, as needed.

In one embodiment, the outer shell or exterior of the self-charging tool device would be manufactured of a hard plastic to maximize durability of the device.

In one embodiment, the internal batteries are lithium, lithium ion, nickel cadmium, nickel zinc, alkaline, lithium polymer, etc., or any other suitable rechargeable battery as is known in the art. Further, the exterior or outer shell is shaped in the mode of ergonomics, which allows the user easy, reliable and comfortable gripping.

In one embodiment, the self-charging tool device comprises a control button or similar control member and display and/or sound and/or luminous alarm component, that alerts a user when the internal batteries are fully charged and/or fully depleted.

In yet another embodiment, the self-charging tool device comprises a plurality of indicia.

In yet another embodiment, a method of generating power to power a tool is disclosed. The method includes the steps of providing a self-charging tool device comprising a rotary engine attached to a power generator. The method also comprises collecting mechanical energy created by the rotary engine. Further, the method comprises converting the mechanical energy to electrical energy. The method also comprises storing the electrical energy in an internal battery. Finally, the method comprises alternating power at a specific point of charge via a double battery and cell system to optimize drill performance and maintain a balance of readily available power.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a cross-sectional view of one embodiment of the self-charging tool device of the present invention showing how the motor is connected to the generator in accordance with the disclosed architecture;

FIG. 2 illustrates a cross-sectional view of one embodiment of the self-charging tool device of the present invention showing the power generator in accordance with the disclosed architecture;

FIG. 3 illustrates a cross-sectional view of one embodiment of the self-charging tool device of the present invention showing how the power is generated during use in accordance with the disclosed architecture;

FIG. 4 illustrates a cross-sectional view of one embodiment of the self-charging tool device of the present invention showing how the power is utilized during use in accordance with the disclosed architecture;

FIG. 5 illustrates a cross-sectional view of one embodiment of the self-charging tool device of the present invention in accordance with the disclosed architecture; and

FIG. 6 illustrates a flowchart showing the method of generating power to power a tool in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a self-charging tool device that provides users with a power tool capable of generating enough power to maintain activation of the tool without charging batteries or a power outlet. There is also a long felt need in the art for a self-charging tool device that features an internal generator that sends power to a battery as the tool is active. Further, there is a long felt need in the art for a self-charging tool device that spins the generator as the tool is being used to generate power and store power within an internal battery. Moreover, there is a long felt need in the art for a device that maintains endless and continuous operation of the tool without the need for a battery charger. Further, there is a long felt need in the art for a self-charging tool device that utilizes a rotary engine attached to the power generator. Finally, there is a long felt need in the art for a self-charging tool device that has a hard plastic shell to maximize durability.

The present invention, in one exemplary embodiment, is a novel self-charging tool device. The self-charging tool device comprises a rotary engine that is attached to a power generator. As the rotary engine powers the tool, the generator collects the mechanical energy created by the engine and converts it to electrical energy that will be stored in an internal battery. Further, the device consists of an internal motor and micro generator system connected to one another. A double battery and cell system would then alternate power at a specific point of charge to optimize drill performance and maintain a balance of readily available power. This will keep the tool permanently charged and eliminate the need for a tool charger. The present invention also includes a novel method of generating power to power a tool. The method includes the steps of providing a self-charging tool device comprising a rotary engine attached to a power generator. The method also comprises collecting mechanical energy created by the rotary engine. Further, the method comprises converting the mechanical energy to electrical energy. The method also comprises storing the electrical energy in an internal battery. Finally, the method comprises alternating power at a specific point of charge via a double battery and cell system to optimize drill performance and maintain a balance of readily available power.

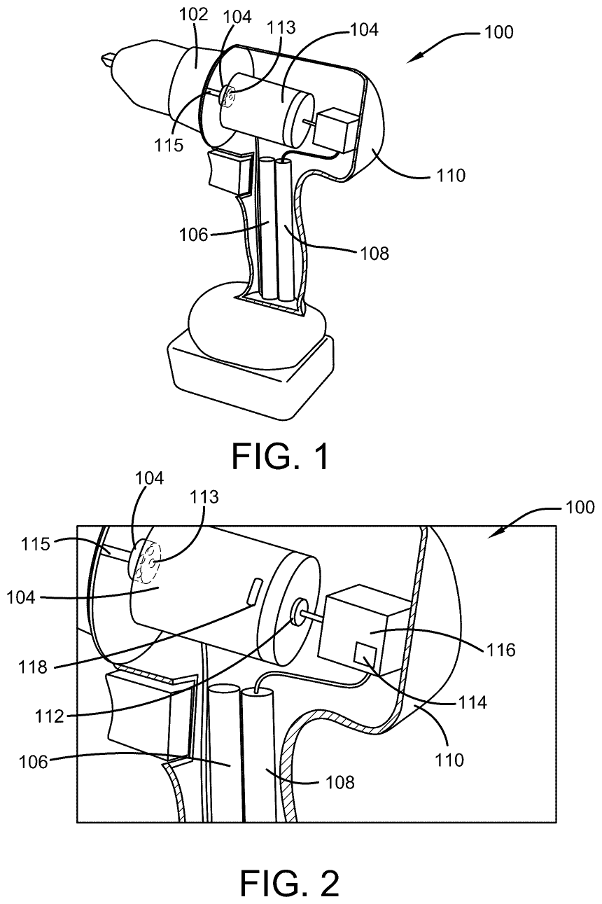

Referring initially to the drawings, FIG. 1 illustrates a cross-sectional view of one embodiment of the self-charging tool device 100 of the present invention. In the present embodiment, the self-charging tool device 100 is an improved self-charging tool device 100 that provides a tool capable of generating enough power to maintain activation of the tool without charging batteries or a power outlet. Specifically, the self-charging tool device 100 comprises a rotary engine 102 attached to a power generator 104. As the rotary engine 102 powers the tool, the generator 104 collects the mechanical energy created by the engine 102 and converts it to electrical energy that will be stored in internal batteries 106, 108. This will keep the device 100 permanently charged and eliminate the need for a tool charger.

Generally, the self-charging tool device 100 provides a set of self-charging power tools that are designed to eliminate the need for tool chargers. Typically, hand-held power tools 110 are adapted with the device 100, but other suitable power tools 110 can be utilized as well. For example, suitable power tools 110 can include, but are not limited to, a drill, a sander, a grinder, a circular saw, etc., or any other suitable hand-held power tool 110 as is known in the art, depending on the needs and/or wants of a user.

As shown in FIG. 2, the self-charging tool device 100 comprises a rotary engine 102 that is attached to a power generator 104. The rotary engine 102 is a conventional rotary engine 102 that uses electrical energy to spin rotors to power the tool 110. The rotary engine 102 powers the hand-held power tool 110, and the power generator 104 collects the mechanical energy created by the rotary engine 102 and converts it to electrical energy that will be stored in an internal battery system 106, 108. Specifically, as the rotors of the rotary engine 102 spin, they act to spin the generator shaft 112 which creates electrical energy for powering the device 100. Further, the power generator 104 is a gear driven micro generator connected with smaller gears 113 to the shaft 115 of the drill. As the drill 110 spins it will also spin the micro generator 104, powering the stored batteries 106 and 108. When one battery 106 reaches low power, the drill 110 automatically alternates to the secondary battery 108 allowing for the first one 106 to charge.

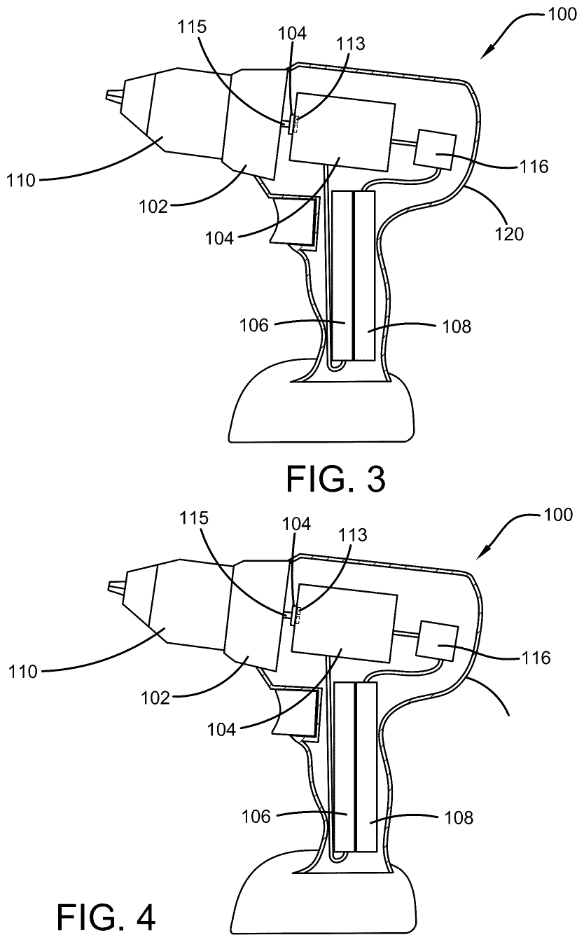

As shown in FIGS. 3-4, the rotary engine 102 and the power generator 104 connect to one another and to an internal double battery system (i.e., a first 106 and second 108 internal battery) to power the device 100. Thus, once the power generator 104 produces a predetermined amount of electrical energy, it is then stored in a first internal battery 106. While this is occurring, the second internal battery 108 is powering the rotary engine 102 to spin or rotate. Then, whenever the first internal battery 106 is fully charged and/or the second internal battery 108 is empty, an electric switch 114 is provided which allows the power generator 104 to then charge the second internal battery 108 while the first internal battery 106 is then used to power the rotary engine 102. Accordingly, the electric switch 114 is provided to be able to switch between the first 106 and second 108 internal batteries, as necessary. Thus, the first 106 and the second 108 internal batteries are charged to a predetermined level and/or depleted to a certain level when the electric switch 114 is activated to transfer power supplies between the internal batteries 106, 108. Accordingly, the double internal battery system 106, 108 would then alternate power at a specific point of charge to optimize drill (i.e., power tool 110) performance and maintain a balance of readily available power. This will keep the device 100 permanently charged and eliminate the need for a tool charger.

In one embodiment, the internal batteries 106, 108 are lithium, lithium ion, nickel cadmium, nickel zinc, alkaline, lithium polymer, etc., or any other suitable rechargeable battery as is known in the art.

Furthermore, the self-charging tool device 100 comprises a controller 116 in communication with the electric switch 114 and the internal batteries 106, 108. In use, the controller 116 detects the internal battery supplies, and triggers the electric switch 114, which allows recharging automatically of the internal batteries 106, 108, as needed.

In one embodiment, the self-charging tool device 100 comprises a control button 118 or similar control member and display and/or sound and/or luminous alarm component, that alerts a user when the internal batteries 106, 108 are fully charged and/or fully depleted. The control button 118 is in communication with the controller 116 which detects the internal battery supplies, to alert a user of the battery 106, 108 charge levels.

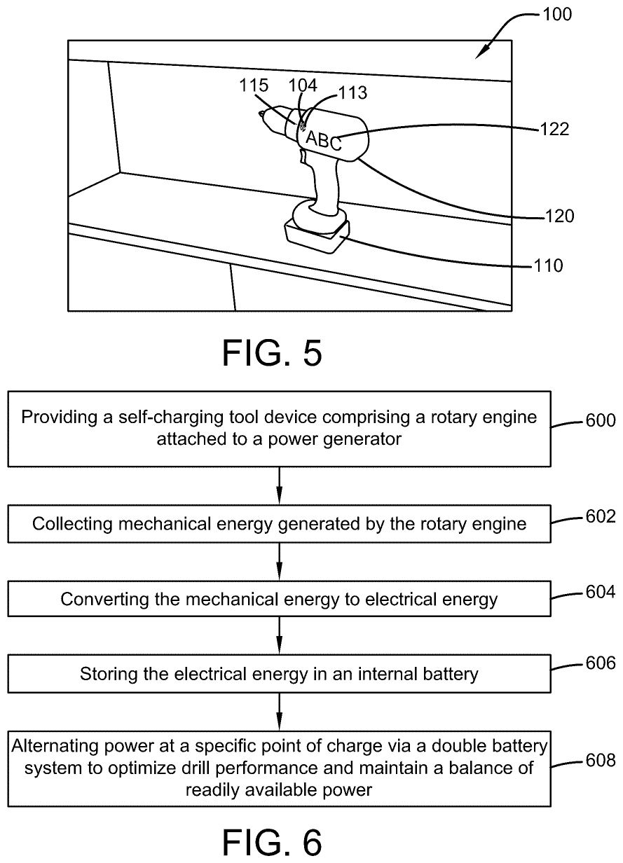

As shown in FIG. 5, the outer shell or exterior 120 of the self-charging tool device 100 would be manufactured of a hard plastic to maximize durability of the device 100. Specifically, the exterior 120 can be manufactured through common molding processes of heat-sealable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc. Further, the exterior 120 is also manufactured from a material that is water resistant or waterproof, or the exterior 120 comprises a coating that is water resistant or waterproof.

In one embodiment, the exterior or outer shell 120 is shaped in the mode of ergonomics, which allows the user easy, reliable and comfortable gripping.

In yet another embodiment, the self-charging tool device 100 comprises a plurality of indicia 122. The exterior 120 of the device 100 may include advertising, a trademark, or other letters, designs, or characters, printed, painted, stamped, or integrated into the exterior 120, or any other indicia 122 as is known in the art. Specifically, any suitable indicia 122 as is known in the art can be included, such as but not limited to, patterns, logos, emblems, images, symbols, designs, letters, words, characters, animals, advertisements, brands, etc., that may or may not be power tool, charging, or brand related.

FIG. 6 illustrates a flowchart of the method of generating power to power a tool. The method includes the steps of at 600, providing a self-charging tool device comprising a rotary engine attached to a power generator. The method also comprises at 602, collecting mechanical energy created by the rotary engine. Further, the method comprises at 604, converting the mechanical energy to electrical energy. The method also comprises at 606, storing the electrical energy in an internal battery. Finally, the method comprises at 608, alternating power at a specific point of charge via a double battery and cell system to optimize drill performance and maintain a balance of readily available power.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “self-charging tool device”, “self-charging device”, “tool device”, and “device” are interchangeable and refer to the self-charging tool device 100 of the present invention.

Notwithstanding the forgoing, the self-charging tool device 100 of the present invention can be of any suitable size and configuration as is known in the art without affecting the overall concept of the invention, provided that it accomplishes the above stated objectives. One of ordinary skill in the art will appreciate that the self-charging tool device 100 as shown in FIGS. 1-6 is for illustrative purposes only, and that many other sizes and shapes of the self-charging tool device 100 are well within the scope of the present disclosure. Although the dimensions of the self-charging tool device 100 are important design parameters for user convenience, the self-charging tool device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A self-charging tool device that provides a tool capable of generating enough power to maintain activation of the tool without charging, the self-charging tool device comprising:
a rotary engine; and
a power generator;
wherein the rotary engine is attached to the power generator;
wherein the rotary engine powers the power generator, which collects electrical energy which is then stored; and
further wherein the power generator keeps the self-charging tool device permanently charged and eliminates need for a tool charger.

2. The self-charging tool device of claim 1, wherein the self-charging tool device are adapted to be utilized with a hand-held power tool, such as a drill, a sander, a grinder, or a circular saw.

3. The self-charging tool device of claim 2, wherein the rotary engine uses electrical energy to spin rotors to power the hand-held power tool.

4. The self-charging tool device of claim 3, wherein the power generator collects mechanical energy created by the rotary engine and converts it to electrical energy that will be stored in an internal battery system.

5. The self-charging tool device of claim 4, wherein the power generator is a gear driven micro generator connected with smaller gears to a shaft of the hand-held power tool, and as the hand-held power tool spins, it will also spin the power generator, powering the internal battery system.

6. The self-charging tool device of claim 5, wherein the rotary engine and the power generator connect to one another and to the internal battery system, comprising a first internal battery and a second internal battery.

7. The self-charging tool device of claim 6, wherein once the power generator produces a predetermined amount of electrical energy, it is then stored in the first internal battery, and while this is occurring, the second internal battery is powering the rotary engine to spin.

8. The self-charging tool device of claim 7, wherein whenever the first internal battery is fully charged and the second internal battery is empty, an electric switch is provided which allows the power generator to then charge the second internal battery while the first internal battery is then used to power the rotary engine.

9. The self-charging tool device of claim 8, wherein the electric switch is provided to be able to switch between the first internal battery and the second internal battery, as necessary.

10. The self-charging tool device of claim 9, wherein the first internal battery and the second internal battery would then alternate power at a specific point of charge to optimize hand-held power tool performance and maintain a balance of readily available power.

11. The self-charging tool device of claim 10, wherein the first and second internal batteries are lithium, lithium ion, nickel cadmium, nickel zinc, alkaline, or lithium polymer.

12. The self-charging tool device of claim 11 further comprising a controller in communication with the electric switch and the first internal battery and the second internal battery.

13. The self-charging tool device of claim 12, wherein the controller detects the internal battery supplies, and triggers the electric switch, which allows recharging automatically of the first and second internal batteries, as needed.

14. A self-charging tool device that provides a tool capable of generating enough power to maintain activation of the tool without charging, the self-charging tool device comprising:
a rotary engine; and
a power generator;
wherein the self-charging tool device are adapted to be utilized with a hand-held power tool;
wherein the rotary engine uses electrical energy to spin rotors to power the hand-held power tool;
wherein the power generator is a gear driven micro generator connected with smaller gears to a shaft of the hand-held power tool;
wherein as the hand-held power tool spins, it will also spin the power generator, powering the internal battery system;
wherein the power generator collects mechanical energy created by the rotary engine and converts it to electrical energy that will be stored in the internal battery system, which is a first internal battery and a second internal battery;
wherein once the power generator produces a predetermined amount of electrical energy, it is then stored in the first internal battery, and while this is occurring, the second internal battery is powering the rotary engine to spin;
wherein whenever the first internal battery is fully charged and the second internal battery is empty, an electric switch is provided which allows the power generator to then charge the second internal battery while the first internal battery is then used to power the rotary engine;
wherein a controller is provided in communication with the electric switch and the first and second internal batteries to detect the internal battery supplies, and triggers the electric switch, which allows recharging automatically of the first and second internal batteries, as needed; and
further wherein the power generator keeps the self-charging tool device permanently charged and eliminates need for a tool charger.

15. The self-charging tool device of claim 14 further comprising a control button which alerts a user when the first and second internal batteries are fully charged or fully depleted.

16. The self-charging tool device of claim 14, wherein an exterior of the self-charging tool device would be manufactured of a hard plastic to maximize durability.

17. The self-charging tool device of claim 16, wherein the exterior is manufactured from a material that is water resistant or waterproof, or the exterior comprises a coating that is water resistant or waterproof.

18. The self-charging tool device of claim 17, wherein the exterior is ergonomically shaped for easy, reliable and comfortable gripping.

19. The self-charging tool device of claim 14 further comprising a plurality of indicia.

20. A method of generating power to power a tool, the method comprising the following steps:
providing a self-charging tool device comprising a rotary engine attached to a power generator;
collecting mechanical energy created by the rotary engine;
converting the mechanical energy to electrical energy;
storing the electrical energy in an internal battery; and
alternating power at a specific point of charge via a double battery system to optimize drill performance and maintain a balance of readily available power.
